(19) United States
(12) Patent Application Publication
(10) Pub. No.: US 2005/0058812 A1
(43) Pub. Date: Mar. 17, 2005

(54) Label having grip tab

(76) Inventors: Peter Seidl, Munchen (DE); Robert Unglert, Munchen (DE); Ulrich Moosheimer, Hohenkammer (DE)

Correspondence Address: WILLIAM COLLARD;COLLARD & ROE, P.C., 1077 NORTHERN BOULEVARD, ROSLYN, NY, 11576, US

(21) Appl. No.: 10/894,963

(22) Filed: Jul. 20, 2004

(30) Foreign Application Priority Data
Jul. 25, 2003 (DE) 103 34 123.4

(51) Int. Cl. B32B 9/00

(52) U.S. Cl. 428/192; 428/40.1

(57) ABSTRACT

The present invention refers to a self-adhesive label, which, after being applied to an object, can be removed from this object as a whole or partially. For removing the label a grip tab is provided, which is non-adhesive or which exhibits reduced adhesivity. The invention is characterized in that the label is reinforced on its underside by a material piece provided at least in the section of the grip tab.

### BACKGROUND OF THE INVENTION

### CROSS REFERENCE TO RELATED APPLICATIONS

Applicants claim priority under 35 U.S.C. §119 of German Application No. 103 34 23.4 filed on Jul. 25, 2003.

1. Field of the Invention

The present invention relates to a self-adhesive label, which, after being stuck onto an object, may be removed again from this object completely or in parts. A grip tab, which is non-adhesive or has only reduced adhesion, is provided for the later removal from the object.

Labels of this type are used in the pharmaceutical industry for identifying containers, for example. The label or sections of the label are to be detached from the container or from the remainder of the label in order to be stuck in a patient file as a voucher. Grip tabs are used to make detaching the label or the section easier. They lie at the outer edge of the label or part of the label and their adhesive force is reduced or canceled out. The user grasps this region and removes the entire label or the section.

### SUMMARY OF THE INVENTION

Especially in the pharmaceutical field, grip tabs of this type are useful aids, since during operations, for example, the labels or sections must often be grasped and removed using sterile plastic gloves. For this purpose, it is necessary to provide a grip tab which is stable and may be grasped easily. This object is achieved according to the present invention by a material piece underneath the label which is non-adhesive or has its adhesive effect reduced.

Furthermore, it is of essential significance that the properties of the label allow it to be applied to an object to be labeled without complications when dispensed. Providing the label on an undamaged material web is thus essential.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawings:

FIGS. 1a and 1b show the design of labels of this type according to the related art.

FIGS. 2a, 2b and 3 show two preferred embodiments of the present invention.

### DETAILED DESCRIPTION OF PREFERRED EMBODIMENTS

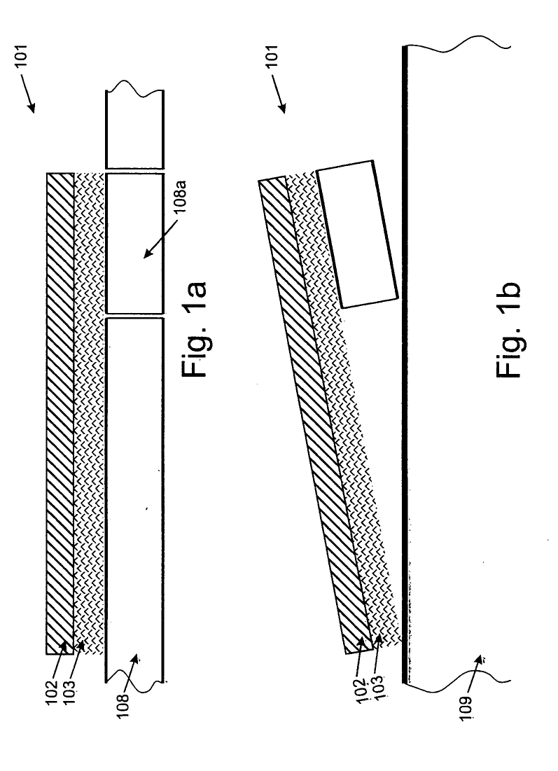

FIG. 1a shows a label 101 according to the related art. It is on a carrier web 108, in which a region 108a is stamped out. The label 101 includes at least one film layer 102 and one adhesive coating 103.

FIG. 1b shows the same label 101 as it is stuck onto an object 109. It may be seen in this case that the stamped-out region 108a of the carrier web is removed together with the label 101 from the remainder of the carrier web and this composite is applied in its entirety onto the object 109.

Because of this, the label has no adhesive bond to the substrate in the region of 108a. In this region, which thus represents a grip tab, the label 101 may be grasped easily, so it may be removed again from the object 109.

As indicated, a label construction as in FIGS. 1a/b has the decisive disadvantage of damaging the carrier material. Because of this, the automatic dispensing of the label using rapidly running dispensing machines is made much more difficult. In addition, the stamped-out part of the carrier material 108a may not be made self-adhesive. The grip tab therefore automatically protrudes easily, especially when stuck onto uneven objects.

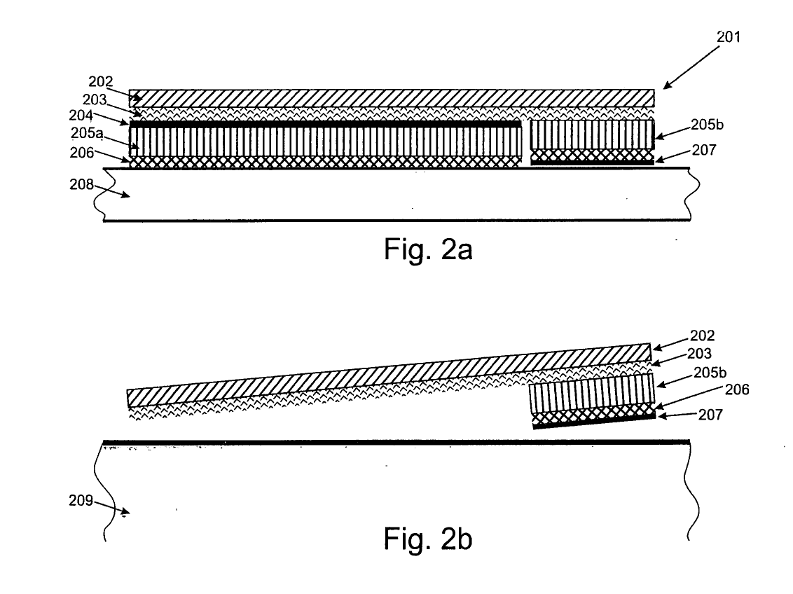

A label construction analogous to FIG. 1a is shown in FIG. 2a, which shows a first preferred embodiment of the present invention: a label 201 also lies on a carrier web 208 in this case. It includes at least one upper film layer 202 and a first adhesive coating 203 lying underneath. The label is divided into two halves below this layer:

On the left in this view, a release coating 204 is applied to a film section 205a under the adhesive coating 203. A second adhesive coating 206 lies under film section 205a. Release coatings such as 204 are typically made of silicone enamels, using which it is possible to precisely set the adhesive forces of the adhesive coating lying above it.

On the right side of FIG. 2a, a material piece 205b, which is typically manufactured by stamping a film 205 into two sections 205a and 205b, lies directly under the first adhesive coating 203. An adhesive coating 206 also lies underneath here, which is provided on the bottom with an agent to cancel out or to reduce the adhesive effect 207. In this way, a grip tab having at least reduced adhesive effect arises, analogously to the related art.

As may be recognized, the label construction shown was manufactured without damaging the carrier material 208. The label 201 may thus be dispensed automatically onto an object, such as a container, without complications. In order to be able to remove a part of the label from this object again, analogously to the procedure in FIG. 1b, one grips below the layer 207 and removes the composite made of the upper film layer 202, the first adhesive coating 203, the material piece 205b, and the layers lying underneath. This composite is shown in FIG. 2b, where it is again stuck onto an object 209, such as a patient file.

The manufacture of the label 201 is distinguished by stamping interposed during the production process. After the application of the film layer 205, including the adhesive coating 206 and the agent 207, which reduces or canceled out the adhesive effect, the film layer 205 is provided on the side shown on the left with the release coating 204. The film layer 205 is then stamped through without stamping through the carrier. In this way, the film section 205a and the material piece 205b lie directly next to one another. Only after the stamping is the upper film 202 having the adhesive 203 laminated onto the composite.

Of course, in the first preferred embodiment of the present invention described here, it is also possible to provide only a part of the upper layer of the label as a removable voucher having a grip tab, so that another part of the upper film layer 202 remains on the film section 205a, the release coating 204 being left off in this region and stamping of the upper film layer 202 being necessary in this case.

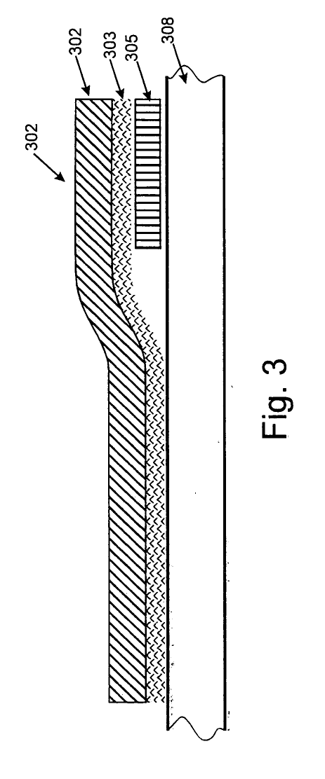

A second preferred embodiment of the present invention is shown in FIG. 3. A label 301 is provided on a carrier web 308 here. It is essentially constructed in one layer, but is two-layered in the right region. A film layer 302 is applied to the carrier web 308 using an adhesive 303. A further layer 305 lies underneath in the right region as a grip aid. By applying this layer, by dispensing it underneath, for example, a grip aid is again provided without damaging the carrier web.

Accordingly, while at least a few embodiments of the present invention have been shown and described, it is to be understood that many changes and modifications may be made thereunto without departing from the spirit and scope of the invention as defined in the appended claims.

1. A label (201, 301) having at least one upper film layer (202,302) and a grip tab, which is not made adhesive or has a reduced adhesive effect,
which is provided on a carrier web,
and is reinforced on the bottom by a material piece (205b, 305) at least in the region of the grip tab,
this material piece not being formed by parts of the carrier web.

2. The label according to claim 1, wherein the material piece (205b) is a part of a further film layer (205a and 205b) under the upper film layer (202).

3. The label according to claim 2, wherein the material piece (205b) lies directly next to a film section (205a).

4. The label according to claim 1, wherein the material piece (205b, 305) has an agent for reducing or canceling out the effect of adhesives.
